(19) United States
(12) Patent Application Publication
(10) Pub. No.: US 2017/0153562 A1
(43) Pub. Date: Jun. 1, 2017

(54) ELECTROSTATIC IMAGE DEVELOPING TONER

(71) Applicant: Konica Minolta, Inc., Tokyo (JP)

(72) Inventors: Makoto NOMIYA, Tokyo (JP); Natsuko Fujisaki, Tokyo (JP); Yasuko Uchino, Tokyo (JP); Tomomi Oshiba, Tokyo (JP)

(21) Appl. No.: 15/271,821

(22) Filed: Sep. 21, 2016

(30) Foreign Application Priority Data
Nov. 26, 2015 (JP) 2015-230258

(51) Int. Cl. G03G 9/087; G03G 9/08

(52) U.S. Cl. CPC G03G 9/08755; G03G 9/0825

(57) ABSTRACT

Provided is an electrostatic image developing toner incorporating toner mother particles containing a binder resin and a releasing agent, wherein the binder resin contains an amorphous polyester resin and a crystalline resin; and the toner mother particles have a region (A) including a structure a formed with the releasing agent and the crystalline resin being in contact with each other, and a region (B) in which the crystalline resin forms a lamellar crystalline structure b independently existing without contacting with the releasing agent.

This application is based on Japanese Patent Application No. 2015-230258 filed on Nov. 26, 2015 with Japan Patent Office, the entire content of which is hereby incorporated by reference.

### TECHNICAL FIELD

The present invention relates to an electrostatic image developing toner. More specifically, the present invention relates to an electrostatic image developing toner exhibiting improved low-temperature fixing property, fixing-separation property, document storage stability, and printing durability.

### BACKGROUND

In accordance with the trend of energy saving in recent years, there have been extensively investigated toners of low-temperature fixing in an electrophotographic image-forming apparatus. As one of the most representative investigation, it may be cited the toner using a crystalline material.

For example, the following technologies were disclosed.

In a toner containing a crystalline resin, two kinds of structures were made in the toner: one is a structure in which the crystalline resin crystals were in contact with the releasing agent; and another is a structure in which the crystalline resin formed a crystalline structure made of only the crystalline resin in the toner. By this composition, it was claimed that the toner has acquired a bend resisting property not depending on the fixing rate (refer to Patent document 1: JP-A No. 2008-33057).

By incorporating a crystalline resin in a lamellar crystalline structure, and by placing crystalline structure on the surface layer of the toner, the toner exhibited excellent storage stability (refer to Patent document 2: JP-A No. 2006-106727).

By incorporating a crystalline resin as threadlike crystals, and by controlling the domain size of the crystals, the toner has achieved an improved low-temperature fixing (refer to Patent document 3: JP-A No. 2013-257415).

Using an amorphous polyester resin as a binder resin has an advantage from the viewpoint of ensuring compatibility of low-temperature fixing property and heat-resisting storage stability.

Further, the melt viscosity can be decreased and the low-temperature fixing can be achieved by adding crystalline polyester (hereafter, it is also called as “CPES”) to amorphous polyester (hereafter, it is also called as “APES”). However, although the known technologies have improved the low-temperature fixing property, there are still requested an improved fixing-separation property and document storage stability. In addition, since the toner loaded on the electrophotographic image-forming apparatus has a tendency of deteriorating during a large amount of printing, there are requested a toner of hardly producing image defect in output images even after usage of extended period of time.

### SUMMARY

The present invention was done based on the above-described problems and situations. An object of the present invention is to provide an electrostatic image developing toner exhibiting improved low-temperature fixing property, fixing-separation property, document storage stability, and printing durability.

The present inventors have made investigation to solve the above-described problems, and have achieved the present invention.

The electrostatic image developing toner of the present invention includes toner mother particles containing a binder resin and a releasing agent, wherein the binder resin contains an amorphous polyester resin and a crystalline resin, and the toner mother particles have a region (A) including a structure a formed with the releasing agent and the crystalline resin being in contact with each other, and a region (B) in which the crystalline resin forms a lamellar crystalline structure b independently existing without contacting with the releasing agent. The above-described toner exhibited improved low-temperature fixing property, fixing-separation property, document storage stability, and printing durability by being provided with the specific structure. Thus the present invention has been achieved.

Namely, the problems relating to the present invention are solved by the following embodiments.
1. An electrostatic image developing toner comprising toner mother particles containing a binder resin and a releasing agent,

wherein the binder resin contains an amorphous polyester resin and a crystalline resin; and

the toner mother particles have a region (A) including a structure a formed with the releasing agent and the crystalline resin being in contact with each other, and a region (B) in which the crystalline resin forms a lamellar crystalline structure b independently existing without contacting with the releasing agent.
2. The electrostatic image developing toner described in the embodiment 1, wherein the crystalline resin contains a crystalline polyester resin.
3. The electrostatic image developing toner described in the embodiments 1 or 2, wherein the region (A) including a structure a has an average domain size in the range of 200 to 2,500 nm.
4. The electrostatic image developing toner described in any one of the embodiments 1 to 3, wherein the region (A) including a structure a has an average domain size in the range of 800 to 1,500 nm.
5. The electrostatic image developing toner described in any one of the embodiments 1 to 4, wherein the region (A) including a structure a has a cross-section ratio of 5 to 15% with respect to a cross-section of the toner mother particle.
6. The electrostatic image developing toner described in any one of the embodiments 1 to 5, wherein the region (B) in which the crystalline resin forms a lamellar crystalline structure b has an average domain size in the range of 100 to 2,000 nm.
7. The electrostatic image developing toner described in any one of the embodiments 1 to 6, wherein the region (B) in which the crystalline resin forms a lamellar crystalline structure b has an average domain size in the range of 500 to 1,500 nm.
8. The electrostatic image developing toner described in any one of the embodiments 1 to 7, wherein the lamellar crystalline structure b has a cross-section ratio of 5 to 10% with respect to a cross-section of the toner mother particle.
9. The electrostatic image developing toner described in any one of the embodiments 1 to 8, wherein the region (A) including a structure a and the region (B) formed with a lamellar crystalline structure b have a cross-section ratio (A/B) in the range of 1.0 to 2.5.
10. The electrostatic image developing toner described in any one of the embodiments 1 to 9, wherein the crystalline resin contains a hybrid crystalline resin formed with a crystalline resin segment and an amorphous resin segment.
11. The electrostatic image developing toner described in the embodiment 10, wherein a content of the amorphous resin segment is in the range of 5 to 30% based on the total mass of the hybrid crystalline resin.

By the above-described embodiments of the present invention, it can provide an electrostatic image developing toner exhibiting improved low-temperature fixing property, fixing-separation property, document storage stability, and printing durability.

A formation mechanism or an action mechanism of the effects of the present invention is not made clear, but it is supposed to be as follows.

As described above, it is known that the low-temperature fixing property is improved by adding a crystalline resin to an amorphous polyester resin.

It was found that when the crystalline resin was placed in a lamellar crystalline structure in the toner mother particle, deformation of the toner at the time of melting was promoted. Therefore, bleed-out of wax was accelerated and it was reduced a contact area of the crystalline resin and the amorphous polyester resin at the fixing process. Thus, excessive mutual dissolution may be avoided. In addition, it was found that bleed-out of the releasing agent is restrained when the releasing agent is made to exist in the structure a in which the releasing agent is in contact with the crystalline resin.

It is supposed that the low-temperature fixing property is improved, and, at the same time, an amount of bleed-out of the wax is suitably controlled by combining these two mechanisms. Further, when a toner has been used for a long period of time under the condition of being subjected to mechanical stress and heat in a developing device of an image-forming apparatus, due to the existence of the structure a in which the releasing agent and the crystalline resin are in contact with each other (for example, a “WAX-CPES” structure), and the lamellar crystalline structure, the releasing agent (for example, wax) and the crystalline resin are prevented from exposing to the surface, and the stress is reduced. By these effects, it is supposed that there is hardly produced image defect in output images even after usage of extended period of time, and printing durability is improved.

Based on the above mechanism, it is supposed that it can provide a toner achieving improvement in the fixing-separation property, document storage property, and printing durability while keeping the low-temperature fixing property.

### BRIEF DESCRIPTION OF THE DRAWINGS

FIG. 1 is a schematic drawing illustrating a structure a in which a releasing agent and a crystalline resin are in contact with each other, and a lamellar crystalline structure b.

FIG. 2 is a transmission electron microscope photograph of a lamellar crystalline structure b made of a crystalline resin.

FIG. 3 is a schematic configuration of an image-forming apparatus.

### DESCRIPTION OF THE PREFERRED EMBODIMENTS

An electrostatic image developing toner of the present invention is a toner comprising toner mother particles each containing at least a binder resin and a releasing agent,

wherein the binder resin contains an amorphous polyester resin and a crystalline resin; and

the toner mother particles have a region (A) including a structure a formed with the releasing agent and the crystalline resin being in contact with each other, and a region (B) in which the crystalline resin forms a lamellar crystalline structure b independently existing without contacting with the releasing agent. This technical feature is common to or corresponds to the inventions relating to the above-described embodiments.

A preferable embodiment of the present invention is that the toner contains a crystalline polyester resin as the crystalline resin from the viewpoint of printing durability.

Another preferable embodiment of the present invention is that the region (A) including a structure a has an average domain size in the range of 200 to 2,500 nm, and more preferably in the range of 800 to 1,500 nm. By satisfying this requirement, it can adjust the amount of bleed out of the releasing agent and compatibility of the crystalline resin and the amorphous polyester resin. Therefore, this is a preferable embodiment.

Another preferable embodiment of the present invention is that the region (A) including a structure a has a cross-section ratio of 5 to 15% with respect to a cross-section of the toner mother particle. By satisfying this requirement, it can adjust an amount of bleed out of the releasing agent and compatibility of the crystalline resin and the amorphous polyester resin. Therefore, this is a preferable embodiment.

Another preferable embodiment of the present invention is that the region (B) in which the crystalline resin forms a lamellar crystalline structure b has an average domain size in the range of 100 to 2,000 nm. By satisfying this requirement, it can adjust an amount of bleed out of the releasing agent and it can also adjust compatibility of the crystalline resin and the amorphous polyester resin. Therefore, this is a preferable embodiment.

Another preferable embodiment of the present invention is that the region (B) in which the crystalline resin forms a lamellar crystalline structure b has an average domain size in the range of 500 to 1,500 nm. Satisfying this requirement is preferable from the viewpoint of ensuring compatibility of the low-temperature fixing property and the document storage stability.

When the lamellar crystalline structure b has a cross-section ratio of 5 to 10% with respect to a cross-section of the toner mother particle, the toner becomes easily melted and deformation of the toner progresses. As a result, the releasing agent will be easily moved, and a stable and excellent image formation can be made during printing. During the fixing step, a suitable amount of releasing agent can be bled out due to the progress of the toner deformation. Thus, the compatibility with the amorphous polyester resin can be adjusted. As a result, high fixing-separation property and excellent document storage stability can be obtained. Consequently, this is a preferable embodiment.

When the region (A) including the structure a and the region (B) formed with the lamellar crystalline structure b have a cross-section ratio (A/B) in the range of 1.0 to 2.5, it can adjust an amount of bleed out of the releasing agent and it can also adjust compatibility of the crystalline resin and the amorphous polyester resin. Therefore, this is a preferable embodiment.

Further, when the crystalline resin contains a hybrid crystalline resin formed with a crystalline resin segment and an amorphous resin segment, the lamellar crystalline structure b is easily formed. Therefore, it is a preferable embodiment.

Further, a content of the amorphous resin segment is preferably in the range of 5 to 30% based on the total mass of the hybrid crystalline resin. When the content of the amorphous resin segment is in this range, the compatibility with the amorphous resin and the plasticity can be achieved to a suitable range. As a result, an excellent low-temperature fixing property and document off-set property can be made.

The present invention and the constitution elements thereof, as well as configurations and embodiments to carryout the present invention, will be detailed in the following. In the present description, when two figures are used to indicate a range of value before and after “to”, these figures themselves are included in the range as a lowest limit value and an upper limit value.

### [General Outline of Electrostatic Image Developing Toner]

An electrostatic image developing toner (hereafter, it may be simply called as “a toner”) according to the present invention contains at least toner mother particles. In the present invention, “a toner” indicates an assembly of “toner particles”. Further, the “toner particles” indicate a material composed of toner mother particles, or a material composed of toner mother particles added with at least an external additive.

In addition, the toner particles may incorporate internal additives such as a coloring agent and a charge controlling agent when required.

The toner mother particles according to the present invention contain at least a binder resin and a releasing agent. The toner mother particles have the following feature. The binder resin contains an amorphous polyester resin and a crystalline resin; and the toner mother particles have a region (A) including a structure a formed with the releasing agent and the crystalline resin being in contact with each other, and a region (B) in which the crystalline resin forms a lamellar crystalline structure b independently existing without contacting with the releasing agent.

[Structure a in Which the Releasing Agent and the Crystalline Resin are in Contact with each other and Lamellar Crystalline Structure b]

A structure a in which the releasing agent and the crystalline resin are in contact with each other is indicated by a numeral 3 in FIG. 1. Hereafter, it may be simply called as a structure a. As illustrated in FIG. 1, the numeral 3 represents a morphology that forms a structure made of one or a plurality of crystalline resin 1 contacting with a releasing agent (wax) 2.

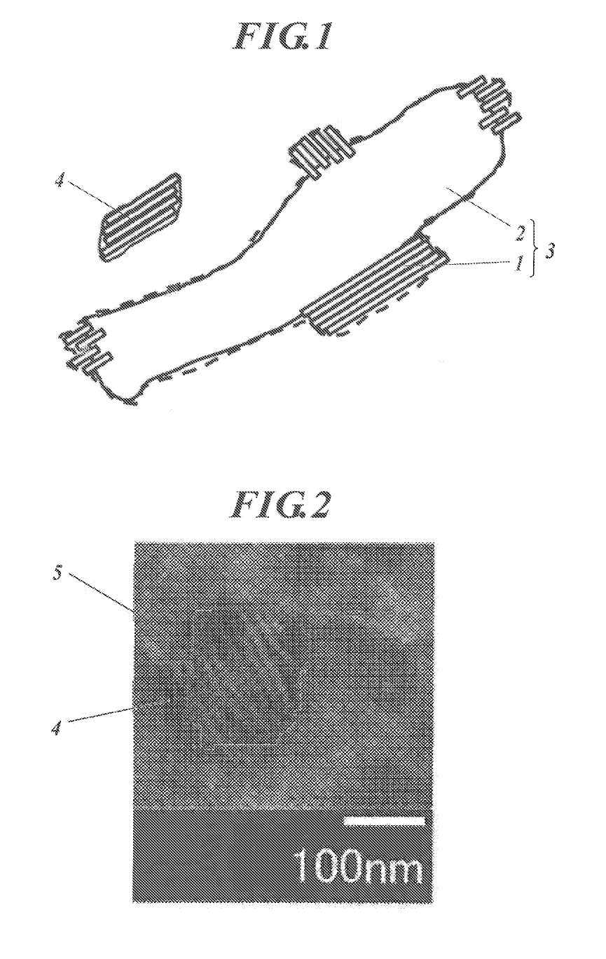

Further, a lamellar crystalline structure represents a layered structure produced by crystallization of a folded molecular chain of a crystalline resin. Specifically, it represents a layered structure produced by crystallization of a folded molecular chain of a crystalline resin as illustrated by a numeral 4 in FIG. 2.

### (Observation of Toner Cross-Section)

A toner cross-section observation may be done by the following conditions. Thereby, the structure a and the lamellar crystalline structure b can be confirmed.

Apparatus: Electron microscope “JSM-7401F” (made by JEOL Co. Ltd.)

Sample: A thin slice of a toner particle (thickness of 60 to 100 nm) dyed with ruthenium tetroxide (RuO₄)

Acceleration voltage: 30 kV

Magnification: 500,000 times

Observation conditions: Transmission electron detector, bright-field image

### (Preparation Method of Thin Slice of Toner Particle)

About 1 to 2 mg of toner is placed in a 10 mL sample tube in a way that the toner may spread in the tube. The toner is treated under a dying condition with a vapor of ruthenium tetroxide (RuO₄), then it is dispersed in a photo curable resin “D-800” (made by JEOL Co. Ltd.) and photo cured to form a block. Subsequently, an ultra-thin slice sample having a thickness of 60 to 100 nm is cut out from the block using a microtome equipped with a diamond blade. Afterward, the cut out sample is again treated under the following conditions for dying.

### (Treatment Condition of Ruthenium Tetroxide)

A ruthenium tetroxide condition is done by using a vacuum electron dying apparatus VSC1R1 (made by Filgen Co. Ld.). Followed by the apparatus procedure, a sublimation chamber including ruthenium tetroxide is placed in a dying apparatus main body. After introducing a toner or an ultra-thin slice sample in the dying chamber, a dying treatment with ruthenium tetroxide is carried out under the condition of: room temperature (24 to 25° C.), a density 3 (300 Pa) for duration of 10 minutes.

### (Observation of Dispersed Particles)

After completion of dying, the sample is observed with an electron microscope “JSM-7401F” (made by JEOL Co. Ltd.) within 24 hours.

### [Average Domain Size]

“An average domain size” is an average value of Feret's diameters obtained from the regions existing as an island state or as a particle state that is isolated or dispersed in a continuous phase (matrix) of a resin component constituting the toner mother particles. The method for obtaining a Feret's diameter will be described later.

Namely, “an average domain size of regions (A) containing a structure a” is a Feret's diameter of a region enclosing a structure a (3) formed with the releasing agent 2 and the crystalline resin 1 contacting with each other as illustrated in FIG. 1. This region is indicated by a dotted line. Similarly, “an average domain size of regions (B) containing a lamellar crystalline structure b” is a Feret's diameter of a region composed of a lamellar crystalline structure b (4) as illustrated in FIG. 1. This region is indicated by a solid line.

A size (an average domain size) of a structure a and a lamellar crystalline structure b in a cross-section of a toner mother particle can be calculated as a horizontal Feret's diameter (FERE H) of a structure a and a lamellar crystalline structure b.

Specifically, cross-sections of the toner mother particles prepared as described above are photographed at a magnification of 50, 000 at an acceleration voltage of 80 kV with a transmission electron microscope JEM-2000FX (made by JEOL Co. Ltd.). The photographic images are read by a scanner, and a horizontal Feret's diameters (FERE H) of a structure a and a lamellar crystalline structure b are measured with an image analyzer LUZEX AP (made by NIRECO Corporation).

Measurement of an average domain size of a structure a and a lamellar crystalline structure b is done for the samples in which both structure a and lamellar crystalline structure bare observable among 100 toner mother particles. The average domain size is obtained as an arithmetic average value.

An average domain size of regions (A) containing a structure a is preferably in the range of 200 to 2,500 nm, and more preferably, in the range of 800 to 1,500 nm.

When an average domain size of regions (A) containing a structure a is in the above-described range, it can restrain plasticizing caused by compatibility with the amorphous polyester resin. At the same time, since an amount of bleed out the releasing agent is made to be optimum, the fixing-separation property is improved. Moreover, since the compatibility of the structure a and the amorphous polyester resin is not progressed too much, the document storage stability is improved. These are preferable points.

An average domain size of regions (B) containing a lamellar crystalline structure b is preferably in the range of 100 to 2,000 nm, and more preferably, in the range of 500 to 1,500 nm.

When an average domain size of regions (B) containing a lamellar crystalline structure b is in the above-described range, the movement of the releasing agent is easily done accompanied by melting and deformation of the toner. In addition, due to the progress of deformation of the toner during the fixing step, a suitable amount of the releasing agent is bled out. Thus, compatibility with the amorphous polyester resin can be adjusted. As a result, high fixing-separation property and high document storage stability can be achieved. These are preferable points.

### [Cross-Section Ratio]

Cross-section ratios of a structure a and a amorphous polyester resin b were calculated as follows.

A photographed image of a cross-section of a toner particle was measured by using “Surface AREA” in an image analyzer LUZEX AP (made by NIRECO Corporation). There were measured an area of a region (A) containing a structure a and an area of a region (B) containing a lamellar crystalline structure b. An area was measured for a region enclosed with an outer outline (for example: the region enclosed by a dotted line in FIG. 1 for a structure a; and the region enclosed by a solid line for a lamellar crystalline structure indicated by numeral 4 in FIG. 1). Similarly, an area of a toner mother particle was measured. A cross-section ratio A (a ratio of a cross-section area of a structure a to a cross-section area of a toner mother particle) and a cross-section ratio B (a ratio of a cross-section area of a lamellar crystalline structure b to a cross-section area of a toner mother particle) were calculated. 100 pieces of toner mother particles were observed. An arithmetic average value for the particle having both structure a and lamellar crystalline structure b was calculated.

From the above-described measurement values, a cross-section ratio (A/B) was obtained. Here, A is an area of a region (A) containing a structure a, and B is an area of a region (B) containing a lamellar crystalline structure b.

The cross-section ratio (A/B) is preferably in the range of 0.1 to 5.0, and more preferably, it is in the range of 1.0 to 2.5. Here, A is an area of a region (A) containing a structure a, and B is an area of a region (B) containing a lamellar crystalline structure b.

Further, the sum of the region (A) containing a structure a and the region (B) containing a lamellar crystalline structure b is preferably in the range of 1 to 50% with respect to a cross-section of the toner mother particle. More preferably, it is in the range of 5 to 30%.

Among the above-described embodiments, a cross-section ratio of the region (A) containing the structure a with respect to the cross-section of the toner mother particle is preferably in the range of 1 to 25%, and more preferably, it is in the range of 5 to 15%.

A cross-section ratio of the region (B) containing the lamellar crystalline structure b with respect to the cross-section of the toner mother particle is preferably in the range of 1 to 25%, and more preferably, it is in the range of 5 to 10%.

By making the cross-section ratio in the above-described value, an amount of bleed out of the releasing agent, and compatibility with the cc may be controlled. Therefore, this is a preferable embodiment.

### [Amorphous Polyester Resin]

An electrostatic image developing toner (hereafter, it may be simply called as a toner) according to the present invention is a toner containing at least an amorphous polyester resin as a binder resin.

The amorphous polyester resin is only required to be a main component of the binder resin. The main component means that the amorphous polyester resin has a largest content among all of the resins contained in the toner. When the amorphous polyester resin is a main component, it can be achieved both low-temperature fixing property and heat-resisting storage stability with a high level. A content of the amorphous polyester resin is preferably in the range of 50 to 99 mass % with respect to the total resins contained in the toner. More preferably, it is in the range of 50 to 95 mass %, and still more preferably, it is in the range of 65 to 95 mass %. When a content of the amorphous polyester resin is 50 mass % or more, both low-temperature fixing property and heat-resisting storage stability can be achieved with a high level. When it is 65 mass % or more, its effect is likely to be increased. When a content of the amorphous polyester resin is too much, the content of the crystalline resin will be relatively decreased. As a result, the effect of improvement in low-temperature fixing property will become weak. Therefore, the content of the amorphous polyester resin is preferably 99 mass % or less, and more preferably, it is 95 mass % or less.

Here, an amorphous polyester resin usable in the present invention is not limited in particular as long as it has an amorphous property. It maybe used a known amorphous polyester resin. Here, “an amorphous polyester resin” designates a polyester resin having no endothermic peak observed by endothermic change measured with a differential scanning calorimetry (DSC).

A production method of an amorphous polyester resin used in the present invention is not limited in particular. It may be produced with a common polymerization method for polyester by making to react an aromatic dicarboxylic acid with a polyhydric alcohol. Further, although the amorphous polyester resin may be a single type of amorphous polyester resin, it may be a mixture of two or more kinds.

An acid component for constituting an amorphous polyester resin is preferably an aromatic dicarboxylic acid. Examples thereof are: phthalic acid, isophthalic acid, terephthalic acid, trimellitic acid, naphthalene-2,6-dicarboxylic acid, malonic acid, mesaconic acid, dimethylisophthalate, fumaric acid, and dodecenylsuccinic acid. Among these, dimethyl isophthalate, terephthalic acid, dodecenylsuccinic acid, and trimellitic acid are preferred.

An alcoholic component for constituting an amorphous polyester resin is preferably a polyhydric alcohol. Examples of a two or three valent alcohol are: ethylene glycol, propylene glycol, 1,4-butanediol, 2,3-butanediol, diethylene glycol, triethylene glycol, 1,5-pentanediol, 1,6-hexanediol, neopentylene glycol, 1,4-cyclohexane dimethanol, dipropylene glycol, polyethylene glycol, polypropylene glycol, ethylene oxide adduct of bisphenol A, propylene oxide adduct of bisphenol A, glycerin, sorbitol, 1,4-sorbitan,and trimethylolpropane.

As described above, it is sufficient that a main component of a toner is an amorphous polyester resin. It may be contained other amorphous resin (for example, a vinyl type resin).

### [Crystalline Resin]

A crystalline resin of the present invention may be contained in the toner as a usual crystalline resin or it may be contained as a hybrid crystalline resin.

A hybrid crystalline resin is a substance having a structure formed with a crystalline resin segment and an amorphous resin segment chemically bonded with each other. The crystalline resin is not limited in particular as long as it has a crystalline property. Any crystalline resins known in the present technical field may be used. Specific examples thereof are: a crystalline polyester resin, a crystalline polyurethane resin, a crystalline polyurea resin, a crystalline polyamide resin, and a crystalline polyether resin. The crystalline resins may be used alone, or they may be used in combination of two or more kinds.

Among them, a preferable crystalline resin is a crystalline polyester resin. Here, “a crystalline polyester resin” is a resin having a clear endothermic peak instead of a stepwise endothermic change measured with differential scanning calorimetry (DSC) among known polyester resins. They are obtained by a polycondensation reaction of a two or more valent carboxylic acid (polycarboxylic acid) or a derivative thereof with a two or more valent alcohol (polyhydric alcohol) or a derivative thereof.

Here, “a clear endothermic peak” designates a peak having a half bandwidth within 15° C. in an endothermic curve obtained by measurement with differential scanning calorimetry (DSC) under the condition of a temperature raising rate of 10° C./min. As a derivative of a polycarboxylic acid, it can be cited an acid anhydride and an acid salt compound. As a derivative of a polyhydric alcohol, it can be cited an ester compound of a polyhydric alcohol and a hydroxy carboxylic acid.

A polycarboxylic acid is a compound having two or more carboxy groups in one molecule. A two valent carboxylic acid is a compound having two carboxy groups in one molecule. Examples thereof are: saturated aliphatic dicarboxylic acids such as oxalic acid, malonic acid, succinic acid, adipic acid, pimelic acid, sebacic acid, azelaic acid, n-dodecyl succinic acid, 1,9-nonane dicarboxylic acid, 1,10-decane dicarboxylic acid (dodecanedioic acid), 1,11-undecanedicarboxylic acid, 1,12-dodecane dicarboxylic acid (tetradecanedioic acid), 1,13-tridecanedicarboxylic acid, and 1,14-tetradecane dicarboxylic acid; alicyclic dicarboxylic acid such as cyclohexane dicarboxylic acid; unsaturated aliphatic dicarboxylic acids such as maleic acid, fumaric acid, citraconic acid, and itaconic acid; and aromatic dicarboxylic acids such asphthalic acid, isophthalic acid, and terephthalic acid. As a polycarboxylic acid other than a two valent carboxylic acid, it can be cited three valent carboxylic acids such as trimellitic acid, and pyromellitic acid. Further, as a derivative of a polycarboxylic acid, it can be cited acid anhydrides and esters of 1 to 3 carbon atoms of these carboxylic acid compounds. These may be used alone, or they may be used in combination of two or more kinds.

A polyhydric alcohol is a compound having two or more hydroxy groups in one molecule. A two valent polyol (diol) is a compound having two hydroxy groups in one molecule. Examples thereof are: aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, neopentyl glycol, and 1,4-tenediol. As a polyhydric alcohol other than a two valent polyol, it can be cited three or more valent polyhydric alcohols such as glycerin, pentaerythritol, trimethylol propane and sorbitol. These may be used alone, or they may be used in combination of two or more kinds.

The crystalline polyester resin may partially have a branched or a cross-linked structure by selection of the valence of the above-described polycarboxylic acid or the valence of the above-described polyhydric alcohol.

The forming method of the crystalline polyester resin using the above-described monomer is not limited in particular. The crystalline polyester resin may be formed through polycondensation (esterification) of the above-described polycarboxylic acid and polyhydric alcohol by using a known esterification catalyst.

Although the crystalline resin of the present invention is not limited in particular, it is preferable to be a hybrid crystalline resin.

The amorphous resin segment introduced in the hybrid crystalline resin has a high affinity to the amorphous resin contained as a main component of the toner. Therefore, the hybrid crystalline resin may be easily blended with the amorphous resin (easily fixable). As a result, a molecular chain of the crystalline resin will be easily arrayed, and it is supposed that a lamellar crystalline structure b will be easily formed.

### [Content (Hybrid Ratio) of Amorphous Resin Segment in Hybrid Crystalline Resin]

In the present invention, a content (a hybrid ratio) of the amorphous resin segment in the hybrid crystalline resin is preferably in the range of 5 to 30%. When the content is in this range, a lamellar crystalline structure b will be easily formed, and the effect of the lamellar crystalline structure b will be effectively exhibited.

### [Content of Crystalline Resin]

In the present invention, a content of the crystalline resin in the toner mother particle is only required to be in the range of 0.1 to 50 mass %. Preferably, it is in the range of 5 to 30 mass %. When the content is in this range, the compatibility with the amorphous resin and plasticization will be made in a suitable range. Consequently, both low-temperature fixing property and document off-set property may be improved.

A melting point (Tm) of a crystalline resin (hereafter, a crystalline resin includes a hybrid crystalline resin) is preferably in the range of 55 to 90° C. When the melting point of the crystalline resin is in the range of 55 to 90° C., a sufficient low-temperature fixing property and excellent hot offset resistivity may be obtained. This is a preferable fixing property.

The melting point of a crystalline resin may be controlled by the composition of the resins. The melting point of a crystalline resin may be measured with a differential scanning colorimetric apparatus (DSC). A person having ordinary skill in the art may control the above-described melting point by the composition of the resins.

The melting point (Tm) of a resin can be measured by using “Diamond DSC” (PerkinElmer Inc.), for example. In the present description, the measuring procedure of the melting point (Tm) was adopted a method as described below.

First, 3.0 mg of measuring sample (resin) was sealed in an aluminum pan and it was placed in a sample holder of the “Diamond DSC”. An empty aluminum pan was used for a reference. A DSC curve was obtained by subjecting the sample to the following steps: a first heating step of raising the temperature from 0° C. to 200° C. at a heating rate of 10° C./min; a cooling step of decreasing the temperature from 200° C. to 0° C. at a cooling rate of 10° C./min; and a second heating step of raising the temperature from 0° C. to 200° C. at a heating rate of 10° C./min in the written order. Based on the DSC curve obtained by this measurement, the top temperature in the endothermic peak (the endothermic peak having a half band width of within 15° C.) derived from the crystalline resin in the first heating step was determined as a melting point (Tm).

### [Releasing Agent (Wax)]

Examples of a releasing agent which may be included in the toner particles of the present invention are: polyolefin having a low-molecular weight such as polyethylene, polypropylene, and polybutene; silicones having a softening point by heating; aliphatic acid amides such as oleic acid amide, erucic acid amide, ricinolic acid amide, and stearic acid amide; vegetable waxes such as carnauba wax, rice wax, candelilla wax, Japan wax, and jojoba oil; animal waxes such as beeswax; hydrocarbon waxes such as paraffin wax, microcrystalline wax, and Fischer-Tropsch wax; and ester waxes such as stearyl stearate, behenyl behenate, butyl stearate, propyl oleate, monostearate glyceride, distearate glyceride, pentaerythritol tetrabehenate, diehyleneglycoi monostearate, dipropylene glycol distearate, distearate diglycerides, sorbitan monostearate, and cholesteryl stearate. These may be used alone, or they may be used in combination of two or more kinds.

When a monoester wax is used as a releasing agent, there is a tendency that the crystalline resin, which independently exists without being in contact with the releasing agent of the present invention, will form a lamellar crystalline structure b. On the other hand, when a hydrocarbon wax is used as a releasing agent, there is a tendency of forming a structure a in which the releasing agent and the crystalline resin are in contact with each other. Although the reasons of these tendencies are not clearly determined, it is supposed as follows. Based on the balance of affinity of the crystalline resin and the adjacent resin, there is produced a lamellar crystalline structure b formed by the crystalline resin independently existing without being in contact with the releasing agent of the present invention, or there is produced a structure a in which the releasing agent and the crystalline resin are in contact with each other.

### [Coloring Agent]

In the toner of the present invention, toner mother particles may contain a coloring agent. It may be cited a known inorganic or organic coloring agent as a coloring agent which maybe used therein. Specific examples of a coloring agent are listed in the following.

Examples of a black coloring agent are: carbon black such as furnace black, channel black, acetylene black, thermal black, and lamp black; and magnetic particles such as magnetite and ferrite.

Examples of a magenta or red coloring agent are: C. I. Pigment Reds 2, 3, 5, 6, 7, 15, 16, 48:1, 53:1, 57:1, 60, 63, 64, 68, 81, 83, 87, 88, 89, 90, 112, 114, 122, 123, 139, 144, 149, 150, 163, 166, 170, 177, 178, 184, 202, 206, 207, 209, 222, 238, and 269.

Examples of an orange or yellow coloring agent are: I. Pigment Oranges 31 and 43; and C. I. Pigment Yellows 12, 14, 15, 17, 74, 83, 93, 94, 138, 155, 162, 180, and 185.

Examples of a green or cyan coloring agent are: C. I. Pigment Blues 2, 3, 15, 15:2, 15:3, 15:4, 16, 17, 60, 62, and 66; and. C. I. Pigment Green 7.

The following dyes may be also used: C. I. Solvent Reds 1, 49, 52, 58, 63, 111, and 122; C. I. Solvent Yellows 2, 6, 14, 15, 16, 19, 33, 44, 56, 61, 77, 79, 80, 81, 82, 93, 98, 103, 104, 112, and 162; and C. I. Solvent Blues 25, 36, 60, 70, 93, and 95.

These coloring agents may be used alone, or they may be used in combination of two or more kinds according to necessity. The content of the coloring agent in the toner mother particles is preferably in the range of 1 to 30 mass %, more preferably in the range of 2 to 20 mass %.

### [Charge Controlling Agent]

The toner mother particles of the present invention may contain a charge controlling agent. Examples of a charge controlling agent are: a metal complex such as a zinc or aluminum complex of salicylic acid (salicylic acid metal complex); a calixarene compound; an organoboran compound, and a fluorine containing quaternary ammonium salt compound.

The content of the charge controlling agent in the toner mother particles is preferably in the range of 0.1 to 10 mass parts, more preferably in the range of 0.5 to 5 mass parts with respect to 100 mass parts of the binder resin in the toner.

### [External Additive]

The toner mother particles of the present invention may be directly used for the electrostatic image developing toner. However, in order to improve the fluidity and cleaning property of the toner, it is preferable to add particles such as inorganic particles or organic particles, or a lubricant to the surface of the toner particles as an external additive.

Various kinds of compounds may be used in combination as an external additive. Examples of particles are: inorganic oxide fine particles such as silica fine particles, alumina fine particles, and titania fine particles; inorganic stearic acid compound fine particles such as aluminum stearate fine particles and zinc stearate fine particles; and inorganic titanium acid compound fine particles such as strontium titanate fine particles and zinc titanate fine particles.

Examples of a lubricant are metallic salts of higher aliphatic acids such as: metallic salts (Al, Cu, Mg, and Ca) of stearic acid; metallic salts (Mn, Fe, Cu, and Mg) of oleic acid; metallic salts (Zn, Cu, Mg, and Ca) of palmitic acid; metallic salts (Zn and Ca) of linoleic acid; and metallic salts (Zn and Ca) of ricinoleic acid. From the viewpoint of heat-resisting storage stability and environmental stability, these external additives may be subjected to a surface treatment by using a silane coupling agent, a titan coupling agent, a higher aliphatic acid, or a silicone oil.

An added amount of the external additive is preferably in the rage of 0.05 to 5 mass parts with respect to 100 mass parts of toner mother particles.

### [Morphology of Toner Mother Particles]

In the toner according to the present invention, the toner mother particles may have a so-called single layer structure, or they may have a core-shell structure (a morphology in which a shell portion forming resin is aggregated and fused on the surface of a core particle). The resin particle having a core-shell structure is composed of a resin region (a shell portion) having a relatively high glass transition temperature placed on a surface of a resin particle (a core particle) that contains a coloring agent or a releasing agent and has a relatively low glass transition temperature.

Here, the core-shell structure is not limited to a structure in which the shell portion completely covers the core particle. It includes a structure in which a part of the core particle is exposed without completely covered with the shell portion, for example

The cross-sectional structure of the core-shell structure may be observed and confirmed with a known method such as a transmission electron microscope (TEM) or a scanning probe microscope (SPM).

### [Production Method of Toner]

As a method of producing an electrostatic image developing toner of the present invention, it may be cited: a pulverization method, a polymerization method, and other known method. As a polymerization method, it may be cited: an emulsion aggregation (polymerization) method, an association aggregation method, a dispersing polymerization method, and a mini-emulsion method. Among them, an emulsion aggregation (polymerization) method is preferably used since it enables to produce a toner having a controlled uniform particle size and containing a crystalline resin. This method is preferable from the viewpoint of obtaining a shape controlling property by addition of a specific inorganic salt to an aqueous medium. Further, this method is preferable since it can easily control the progress of the crystal growth from the viewpoint of thermodynamic stability. Moreover, the emulsion aggregation (polymerization) method enables to easily obtain toner mother particles having a small particle size from the viewpoint of production cost and production stability.

As a production method realizing a specific constitution of the present invention that “the toner mother particles includes: a structure a formed with a releasing agent and a crystalline resin being in contact with each other; and a crystalline resin having a lamellar crystalline structure b independently existing without contacting with the releasing agent”, it is preferable that the production method has a cooling step after carrying out controlling step of a particle size and a shape of the toner mother particles. It is also preferable that the production method may control the cooling step.

By conduction the cooling step, it may be avoided aggregation of a crystalline material (for example, a crystalline resin or a releasing agent). As a result, it is supposed that a coexisting condition of the structure a and the lamellar crystalline structure b is easily achieved. In the cooling step, it is preferable to conduct rapid cooling. Here, the rapid cooling means a condition having a temperature decreasing rate of 8° C./min or more, although it depends on the temperature before the cooling and the temperature to be achieved after cooling. By conduction the cooling step (preferably, the rapid cooling step) after carrying out controlling of a particle size and a shape of the toner mother particles, it may easily keep the coexisting condition of: the structure a in which a releasing agent and a crystalline resin being in contact with each other; and the crystalline resin having a lamellar crystalline structure b independently existing without contacting with the releasing agent. When the emulsion aggregation method is employed, it is more preferable that the aggregation is done to obtain a required particle size, then shape control is done by carrying out fusion of the resin particles with each other, and then, the cooling step (preferably, the rapid cooling step) is done.

The emulsion aggregation method is a method of producing toner mother particles having the following steps: forming a dispersion liquid composed of resin particles prepared by an emulsion (hereafter, they may be called as “resin particles”); aggregating the dispersion liquid of the resin particles with colorant agent particles when needed (hereafter, they may be called as “colorant agent particles”) to achieve a required particle size; and controlling the shape of particles by carrying out fusion of the resin particles with each other to obtain toner mother particles. Here, the resin particles may contains a releasing agent or a charge controlling agent according to necessity.

### [Image-Forming Apparatus]

It will be described an example of an image-forming apparatus suitably equipped with an electrostatic image developing toner of the present invention.

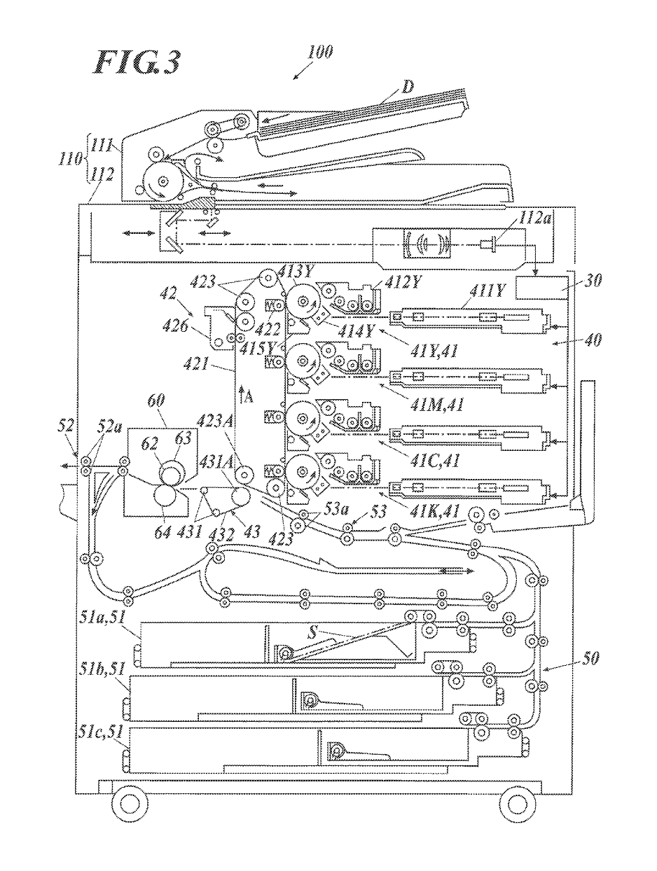

An image-forming apparatus 100 illustrated in FIG. 3 includes an image reading section 110, an image processing section 30, an image-forming section 40, a sheet conveyance section 50, and a fixing device 60.

The image-forming section 40 contains image-forming units 41Y, 41M, 41C, and 41K each forming an image of each color of Y(yellow), M(magenta), C(cyan), and K(Black). Since these units each have the same composition except the incorporated toner, the symbol designating the color may be omitted hereafter. The image-forming section 40 further contains an intermediate transfer unit 42 and a secondary transfer unit 43. These correspond to a transfer device.

Each of the image-forming units 41 includes an exposure device 411, a developing device 412, a photoreceptor drum 413, a charging device 414, and a drum cleaner 415.

The photoreceptor drum 413 is a negatively-charged organic photoreceptor, for example. The surface of the photoreceptor drum 413 has a photoconductive property. The photoreceptor drum 413 corresponds to a photoreceptor. The charging device 414 is a corona discharge generator, for example. The charging device 414 may be a contact charging device which contacts with the photoreceptor drum 413 through a contact charging member such as a charging roller, a charging brush, or a charging blade to result in charging. The exposure device 411 includes a semi-conductor laser as a lighting source, and a light polarization device (polygon motor) that irradiates laser light to the photoreceptor drum 413 in accordance with the image to be formed.

The developing device 412 is a device using a two-component developing method. The developing device 412 contains: a developing container that contains a two-component developer, a developing roller (a magnetic roller) rotatably placed at the opening portion of the developing container, a partition that divides the inside of the developing container in a way that the two-component developer may communicate, a transport roller for transporting the two-component developer at the opening side of the developing container toward the developing roller, and a mixing roller that mixes the two-component developer in the developing container. The developing container contains the above-described toner as a two-component developer.

The intermediate transfer unit 42 includes an intermediate transfer belt 421, a primary transfer roller 422 that presses the intermediate transfer belt 421 to the photoreceptor drum 413, a plurality of support rollers 423 including a backup roller 423A, and a belt cleaner 426. The intermediate transfer belt 42 is stretched in a loop state over a plurality of support rollers 423. Rotation of at least one driving roller among the plurality of support rollers 423 causes the intermediate transfer belt 421 to run in the direction indicated by an arrow A at a constant speed.

The secondary transfer unit 43 contains: a secondary transfer belt 432 having an endless shape, and a plurality of support rollers 431 including a secondary transfer roller 431A. The secondary transfer belt 43 is stretched in a loop state over support rollers 431.

The fixing device 60 includes: a fixing roller 62, a heating belt 63 of an endless belt that covers the outer peripherical surface of the fixing roller 62 so as to heat and melt the toner constituting the toner image on a sheet S, and a pressure roller 64 that presses the sheet S to the fixing roller 62 and the heating belt 63.

The image-forming apparatus 100 further includes the image reading section 110, the image processing section 30, and the sheet conveyance section 50. The image reading section 110 includes a sheet feeding device 111 and a scanner 112. The sheet conveyance unit 50 includes a sheet feeding section 51, a sheet output section 52, and a sheet pathway section 53. Three tray units 51a to 51c that constitute the sheet feeding section 51 each respectively contain the predetermined sheets S (a standard sheet and a special sheet) identified based on the weight and the size. The sheet pathway section 53 contains a plurality of transport roller pairs such as a pair of register rollers.

An image-forming process with the image-forming apparatus 100 will be described.

The scanner 112 reads a draft Don a contact glass through optical scanning. The reflective light from the draft D is read by a CCD sensor 112a. This reflective light becomes an input image data. The input image data is subjected to a predetermined image processing in the image processing section 30, and it is sent to the exposure device 411.

The photoreceptor drum 413 rotates with a predetermined peripheral speed. The charging device 414 uniformly charges the surface of the photoreceptor drum 413 with a negative polarity. In the exposure device 411, a polygon mirror of the polygon motor rotated with a high speed. The laser light corresponding to the input image data of each color component is moved along with the axis direction of the photoreceptor drum 413. The laser light is irradiated in the axis direction of the outer peripherical surface of the photoreceptor drum 413. Thus, an electrostatic latent image is formed on the surface of the photoreceptor drum 413.

In the developing device 412, the toner particles are charged by mixing and transporting of the two-component developer in the developer container. The two-component developer is transported to the developing roller, and it forms a magnetic brush on the developing roller. The charged toner particles electrostatically adhere to the electrostatic latent image portion on the surface of the photoreceptor drum 413. In this way, the electrostatic latent image on the surface of the photoreceptor drum 413 is visualized. It is formed a toner image corresponding to the electrostatic latent image.

The toner image on the surface of the photoreceptor drum 413 is transferred to the intermediated transfer belt 421 in the intermediate transfer unit 42. After transfer of the toner, the remaining toner on the surface of the photoreceptor drum 413 is removed by the drum cleaner 415 having a drum cleaning blade which slidably contacts with the surface of the photoreceptor drum 413.

The intermediate transfer belt 421 is pressed against the respective photoreceptor drums 413 through the primary transfer rollers 422. As a result, there are formed primary transfer nip parts for each photoreceptor drum by the photoreceptor drums 413 and the intermediate transfer belt 421. In the primary transfer nip part, each toner image is sequentially transferred to the intermediate transfer belt 421.

On the other hand, the secondary transfer roller 431A is pressed against the backup roller 423A through the intermediate transfer belt 421 and the secondary transfer belt 432. There is formed a secondary transfer nip part by the intermediate transfer belt 421 and the secondary transfer belt 432. The sheet S passes through the secondary transfer nip part. The sheet S is transported to the secondary transfer nip part by the sheet conveyance section 50. The correction of an inclination of the sheet S and adjustment of the timing of the transport are done in the register roller section located with a pair of register rollers 53a.

When the sheet S is transferred to the secondary transfer nip part, a bias voltage for transfer is applied to the secondary transfer roller 431A. By application of the bias voltage for transfer, the toner images held on the intermediate transfer belt 421 are transferred onto the sheet S. The sheet S on which the toner images have been transferred is conveyed to the fixing unit 60.

The fixing device 60 forms a fixing nip part by the heating belt 63 and the pressure roller 64. The conveyed sheet S is heated and pressed in the fixing nip part. The toner particles constituting the toner image of the sheet S are heated. The crystalline core substance and the hybrid crystalline resin are promptly melted in the toner particles. As a result, the whole toner particles melt with a relatively small amount of heat, and the toner component adheres to the sheet S. In the melted toner component, the crystalline core substance and the peripheral part thereof are rapidly crystallized. Thus, the whole melted toner component becomes solidified. In this manner, the toner image is rapidly fixed on the sheet S with a relatively small amount of heat. The sheet S having a fixed image is ejected outside the apparatus through the sheet output section 52 equipped with a sheet output roller 52a. Thus, it is formed a high quality image.

The transfer-remaining toner remained on the surface of the intermediate transfer belt 421 after the secondary transfer is removed by the belt cleaner 426 having a belt cleaning blade that slidably contacts with the surface of the intermediate transfer belt 421.

### EXAMPLES

Hereinafter, specific examples of the present invention will be described, but the present invention is not limited thereto. In the present examples, the description of “parts” or “%” is used, it represents “mass parts” or “mass %” unless specific notice is given.

A molecular weight (a weight average molecular weight (Mw) and a number average molecular weight (Mn)) was measured with gel permeation chromatography (GPC).

Specifically, a device “HLC-8120 GPC” (TOSOH Corp.) and a column set “TSK guard column+3×TSK gel Super HZM-M” (TOSOH Corp.) were used. The column temperature was held at 40° C., and tetrahydrofuran (THF) was supplied at a flow rate of 0.2 mL/min as a carrier solvent. The measuring sample (resin) was dissolved in tetrahydrofuran to a concentration of 1 mg/mL by a treatment with an ultrasonic disperser at room temperature for 5 minutes. The solution was then treated with a membrane filter having a pore size of 0.2 μm to obtain a sample solution. An aliquot (10 μL) of the sample solution was injected into the device along with the carrier solvent and was detected by means of a refractive index (RI) detector. The molecular weight distribution of the sample was calculated by using a calibration curve, which was determined by using standard monodisperse polystyrene particles. 10 kinds of polystyrene particles were used for making a calibration curve.

A glass transition temperature (Tg) of a resin and a melting point of a releasing agent were determined from a DSC curve obtained in the same manner as measurement of the melting point of the above-described resin.

A glass transition temperature (Tg) of a resin was determined as follows. An extended line of a base line at the starting-up of a first endothermic peak in a second temperature increasing step was drawn and a tangential line from the starting-up to the top of the first endothermic peak was drawn. The cross point of these two lines was determined as a glass transition temperature.

A melting point of a releasing agent (Tm) was determined as a temperature of a peak top point of an endothermic peak in the first temperature increasing step.

### [Preparation of Dispersion Liquid A1]

A solution mixed with 60 mass parts of behenyl behenate (mp. 73° C.) (as a releasing agent), 5 mass parts of ionic surface active agent “NEOGEN RK” (made by DKS Co. Ltd.), and 240 mass parts of ion-exchanged water was heated to 95° C., and it was fully dispersed using a homogenizer “ULTRATAX T50” (made by IKA Co. Ltd.). Then, the dispersion liquid was further subjected to a dispersion treatment by using a Manton Gaulin homogenizer. Thus, it was prepared a dispersion liquid A1 containing the releasing agent particles in a solid content of 20 mass %. A volume average particle size of the particles in the dispersion liquid A1 was 240 nm.

### [Preparation of Dispersion Liquids A2 to A4]

Dispersion liquids A2 to A4 were prepared in the same manner as preparation of the dispersion liquids A1 except that the kind of releasing agent was changed as indicated in Table 1.

### [Preparation of Hybrid Crystalline Polyester Resin HBC1 and its Dispersion Liquid B1]

The following raw material monomers for a poly-condensation resin (crystalline polyester resin: CPES) unit were introduced in a four-necked flask equipped with a nitrogen introducing device, a dehydration tube, a stirrer, and a thermocouple. Then, the mixture was heated to 170° C. to dissolve the content. Thus, a solution H-1 was obtained.

| | |
|---|---|
| Tetradecanedioic acid | 271 mass parts |
| 1,6-Hexanediol | 118 mass parts |

Then, 0.8 mass parts of Ti(OBu)₄ were added as an esterification catalyst to the solution H-1, and the mixture was heated to 235° C. The reaction was made under a normal pressure (101.3 kPa) for 5 hours, then further, the reaction was made under a reduced pressure (8 kPa) for 1 hour. By this, a crystalline polyester resin CP1 was obtained.

The following raw material monomers were introduced in a four-necked flask equipped with a nitrogen introducing device, a dehydration tube, a stirrer, and a thermocouple. Then, the mixture was heated to 170° C. to dissolve the content. Thus, a solution I-1 was obtained.

| | |
|---|---|
| Bisphenol A-propylene oxide adduct (1:2 in mole) | 28.1 mass parts |
| Terephthalic acid | 7.3 mass parts |
| Fumaric acid | 5.5 mass parts |
| Trimellitic acid | 2.3 mass parts |

Then, 0.8 mass parts of Ti(OBu)₄ were added as an esterification catalyst to the solution I-1, and the mixture was heated to 235° C. The reaction was made under a normal pressure (101.3 kPa) for 5 hours, then further, the reaction was made under a reduced pressure (8 kPa) for 1 hour. All of the above-described resin CP1 was added to the obtained reaction solution. The solution was mixed uniformly, and the reaction was made under a reduced pressure (8 kPa) for 1 hour. By this reaction, it was obtained a hybrid crystalline polyester resin HBC1 (hybridized ratio of 10%) having a structure of a main chain made of amorphous polyester resin a grafted side chain made of CP1. The hybrid crystalline polyester resin HBC1 had a molecular weight (Mn) 6,900 and a melting point of 77.2° C.

200 mass parts of the hybrid crystalline polyester resin HBC1 were dissolved in 200 mass parts of ethyl acetate, then, the solution was stirred. To the stirred solution was added gradually an aqueous solution containing sodium polyoxyethylene lauryl ether sulfate in a content of 1 mass part in 800 mass parts of ion-exchanged water. The obtained solution was subjected to a reduced pressure to remove ethyl acetate. Then, the solution was adjusted to pH 8.5 with an aqueous ammonia solution. Subsequently, the solid content was adjusted to 30 mass %. Thus, it was prepared a dispersion liquid B1 containing fine particles of the hybrid crystalline polyester resin HBC1 dispersed in an aqueous medium. The particles contained in the dispersion liquid B1 have a median diameter of 205 nm. The above-described step was done at a temperature under which the hybrid crystalline polyester resin melted.

### [Preparation of Solutions H-2 to H-9 and Dispersion Liquids B2 to B9]

Hybrid crystalline resins HBC2 to HBC9 and dispersion liquids B2 to B9 were prepared in the same manner as preparation of the solution H-1 and the dispersion liquid B1 except that the kinds and the amount of the monomers for the solution H-1, and for the solution I were changed as indicated in Table 2-1 to Table 2-3.

The molecular weight (Mn) and the melting point (Tm) of the hybrid crystalline resins HBC1 to HBC9 were indicated in Table 2-4. The volume based median diameters of the particles contained in the dispersion liquids B2 to B9 were in the range of 190 to 230 nm.

### [Preparation of Dispersion Liquid C]

The following raw material monomers for a poly-condensation resin (amorphous polyester resin) unit were introduced in a four-necked flask equipped with a nitrogen introducing device, a dehydration tube, a stirrer, and a thermocouple. Then, the mixture was heated to 170° C. to dissolve the content.

| | |
|---|---|
| Bisphenol A-propylene oxide adduct (1:2 in mole) | 285.7 mass parts |
| Terephthalic acid | 66.9 mass parts |
| Fumaric acid | 47.4 mass parts |

Then, 0.4 mass parts of Ti(OBu)₄ were added as an esterification catalyst to the obtained solution, and the mixture was heated to 235° C. The reaction was made under a normal pressure (101.3 kPa) for 5 hours, then further, the reaction was made under a reduced pressure (8 kPa) for 1 hour.

Then, after the obtained reaction solution was cooled to 200° C., the reaction was made under a reduced pressure (20 kPa) to achieve the required softening point. Subsequently, the solvent was removed, and an amorphous polyester resin c was obtained. The amorphous polyester resin c had a glass transition temperature Tg of 60° C., and a molecular weight (Mw) of 19,000.

100 mass parts of the amorphous polyester resin c were dissolved in 400 mass parts of ethyl acetate (made by Kanto Kagaku Co. Ltd.). The prepared solution was added to 360 mas parts of aqueous solution of sodium polyoxyethylene lauryl ether sulfate having a content of 0.26 mass %. While stirring the mixture, it was dispersed using an ultrasonic homogenizer “US-150T” (made by Nippon Seiki Co. Ltd.) with V-LEVEL at 300 μA for 30 minutes. Subsequently, ethyl acetate was completely removed at 40° C. with stirring under a reduced pressure for 3 hours by using a diaphragm vacuum pump “V-700” (made by BUCHI Co. Ltd.). Thus, it was prepared a dispersion liquid C containing fine particles of amorphous resin X2 dispersed in an aqueous medium with a solid content of 13.5 mass %. The volume based median diameter of the particles contained in the dispersion liquids C was 190 nm.

### [Preparation of Dispersion Liquid Dcy]

90 mass parts of sodium dodecyl sulfate were added to 1,600 mass parts of ion-exchanged water. While stirring this solution, 420 mass parts of copper phthalocyanine were gradually added to the solution. Subsequently, the solution was subjected to a dispersion treatment using a stirrer “CLEARMIX” (M Technique Co., Ltd.). Thus it was obtained an aqueous dispersion liquid Dcy that contained colorant agent particles. An average particle size (volume based median diameter) of the colorant agent particles in the dispersion liquid Dcy was 110 nm.

### [Preparation of Toner Mother Particles E1]

Into a reaction vessel equipped with a stirrer, a temperature sensor and a cooling tube, 280 mass parts (in solid fraction) of the dispersion liquid C, 50 mass parts (in solid fraction) of the dispersion liquid B1, and 1,000 mass parts of ion-exchanged water were charged. Thereafter, the pH was adjusted to 10 by adding 5 mol/L sodium hydroxide aqueous solution.

Thereafter, 23 mass parts (in solid fraction) of the dispersion liquid Dcy were added thereto. Further, there were added 21.5 mass parts (in solid fraction) of the dispersion liquid A1, and 21.5 mass parts (in solid fraction) of the dispersion liquid A3. Then, while stirring, an aqueous solution of 60 mass parts of magnesium chloride dissolved in 60 mass parts of ion-exchanged water were added at 30° C. over a period of 10 minutes. After leaving the mixture for 3 minutes, the temperature of the system was raised to 80° C. over a period of 60 minutes, and the temperature was held at 80° C. to allow the particle growth reaction to continue.

While keeping this condition, the particle size of the aggregated particles was measured by using a “Coulter Multisizer 3” (Beckman Coulter, Inc.). When the volume based median particle size reached 6,400 nm, an aqueous solution containing 190 mass parts of sodium chloride dissolved in 760 mass parts of ion-exchanged water was added to terminate the particle growth.

Then, the reaction system was further heated and stirred at 90° C. to allow fusion of the particles to proceed. When the average circularity of the toner reached 0.945, the reaction system was cooled to 30° C. at a cooling rate of 2.5° C./min. The average circularity of the toner was measured by a measuring apparatus “FPIA-2100” (Sysmex Corp.) (HPF detect number of 4,000).

Then, solid-liquid separation was carried out, and a dewatered toner cake was washed by repeating re-dispersion in ion-exchanged water and solid-liquid separation for 3 times. Thereafter, the toner cake was dried at 40° C. for 24 hours to obtain toner mother particles E1.

### [Preparation of Toner Mother Particles E2 to E17]

Toner mother particles E2 to E17 were produced in the same manner as preparation of the toner mother particles El except that the dispersion liquids A1, A3, and B1 were changed as indicated in Table 3.

When only one kind of liquid dispersion A was used, the added amount thereof was made to be 43 mass parts (in solid fraction).

### [Preparation of External Additive-Added Toners F1 to F17]

To 100 mass parts of the obtained toner mother particles were added 0.6 mass parts of hydrophobic silica (number average primary particle size=12 nm, hydrophobicity=68) and 1.0 mass parts of hydrophobic titanium oxide (number average primary particle size=20 nm, hydrophobicity=63). The mixture was blended by using a “Henschel mixer” (Nippon Coke & Engineering Co., Ltd.) with a rotary blade circumferential speed of 35 mm/sec at 32° C. for 20 minutes. Thereafter, the coarse particles were removed with a sieve having a mesh of 45 μm. Thus, an external additive-added toner F1 was prepared. In the same manner, external additive-added toners F2 to F17 were prepared by respectively using toner mother particles E2 to E17.

[Preparation of developers G1 to G17]

A ferrite carrier covered with a silicone resin and having a volume based average particle size of 60 μm was added to external additive-added toner F1 so that the content of the toner particles became to be 6 mass %. Thus, it was produced a two-component developer G1.

In the same manner, developers G2 to G17 were produced by respectively using the external additive-added toners F2 to F17.

TABLE 1

| Dispersion | Releasing agent | |
|---|---|---|
| liquid name | Kind | Melting point (° C.) |
| A1 | Behenyl behenate | 73 |
| A2 | Pentaerythritol tetrabehenate | (74)*¹, 83 |
| A3 | Fischer-Tropsch wax | 76 |
| A4 | Microcrystalline wax | (60~85)*¹, 83 |

*¹The value in ( ) is not a main peak

TABLE 2-1
Monomer used in solution H

| | | Added | | Added |
|---|---|---|---|---|
| Solution | Raw material | amount | Raw material | amount |
| number | diol | (Mass parts) | dicarboxylic acid | (Mass parts) |
| H-1 | 1,6-Hexanediol | 118.0 | Tetradecane | 271.0 |
| | | | dicarboxylic acid | |
| H-2 | 1,6-Hexanediol | 123.9 | Tetradecane | 284.5 |
| | | | dicarboxylic acid | |
| H-3 | 1,6-Hexanediol | 104.8 | Tetradecane | 240.8 |
| | | | dicarboxylic acid | |
| H-4 | 1,6-Hexanediol | 91.7 | Tetradecane | 210.7 |
| | | | dicarboxylic acid | |
| H-5 | 1,4-Butanediol | 96.9 | Tetradecane | 292.1 |
| | | | dicarboxylic acid | |
| H-6 | Ethylene glycol | 79.4 | Dodecane | 309.6 |
| | | | dicarboxylic acid | |
| H-7 | 1,6-Hexanediol | 127.7 | Dodecane | 261.3 |
| | | | dicarboxylic acid | |
| H-8 | 1,6-Hexanediol | 127.8 | Tetradecane | 293.4 |
| | | | dicarboxylic acid | |
| H-9 | 1,6-Hexanediol | 85.1 | Tetradecane | 195.4 |
| | | | dicarboxylic acid | |

TABLE 2-2
Monomer used in solution I

| | Bisphenol A | | | |
|---|---|---|---|---|
| | propylene oxide | Terephthalic | | |
| Solution | 2 mole adduct | acid | Fumaric acid | Trimellitic acid |
| number | (Mass parts) | (Mass parts) | (Mass parts) | (Mass parts) |
| I-1 | 28.1 | 7.3 | 5.5 | 2.3 |
| I-2 | 14.0 | 3.6 | 2.7 | 1.2 |
| I-3 | 56.2 | 14.6 | 11.0 | 4.6 |
| I-4 | 84.3 | 21.9 | 16.5 | 6.9 |
| I-5 | 28.1 | 7.3 | 5.5 | 2.3 |
| I-6 | 28.1 | 7.3 | 5.5 | 2.3 |
| I-7 | 28.1 | 7.3 | 5.5 | 2.3 |
| I-8 | 7.0 | 1.8 | 1.4 | 0.58 |
| I-9 | 98.4 | 25.6 | 19.3 | 8.1 |

TABLE 2-3

| | Hybrid | | | |
|---|---|---|---|---|
| Dispersion | crystalline | | | Hybrid ratio |
| liquid | resin | Solution H | Solution I | (%) |
| B1 | HBC1 | H-1 | I-1 | 10 |
| B2 | HBC2 | H-2 | I-2 | 5 |
| B3 | HBC3 | H-3 | I-3 | 20 |
| B4 | HBC4 | H-4 | I-4 | 30 |
| B5 | HBC5 | H-5 | I-5 | 10 |
| B6 | HBC6 | H-6 | I-6 | 10 |
| B7 | HBC7 | H-7 | I-7 | 10 |
| B8 | HBC8 | H-8 | I-8 | 2.5 |
| B9 | HBC9 | H-9 | I-9 | 35 |

TABLE 2-4

| | | | | Carbon | Carbon |
|---|---|---|---|---|---|
| | | Number | | number | number of |
| | Hybrid | average | Melting | of raw | raw material |
| Dispersion | crystalline | molecular | point (Tm) | material | dicarboxylic |
| liquid | resin | weight (Mn) | (° C.) | diol | acid |
| B1 | HBC1 | 6900 | 77.2 | 6 | 14 |
| B2 | HBC2 | 7200 | 79.5 | 6 | 14 |
| B3 | HBC3 | 6000 | 76.0 | 6 | 14 |
| B4 | HBC4 | 5100 | 74.0 | 6 | 14 |
| B5 | HBC5 | 5000 | 85.0 | 4 | 14 |
| B6 | HBC6 | 7500 | 88.0 | 2 | 12 |
| B7 | HBC7 | 4500 | 81.0 | 6 | 12 |
| B8 | HBC8 | 7400 | 80.5 | 6 | 14 |
| B9 | HBC9 | 4300 | 72.5 | 6 | 14 |

TABLE 3

| External | Toner | Dispersion | | | |
|---|---|---|---|---|---|
| additive-added | mother | liquid A | | WAX blend | Dispersion liquid B |
| toner | particles | (WAX) | | ratio | (Crystalline resin) |
| F1 | E1 | A1 | A3 | 50/50 | B1 |
| F2 | E2 | A1 | A3 | 50/50 | B2 |
| F3 | E3 | A1 | A3 | 50/50 | B3 |
| F4 | E4 | A1 | A3 | 50/50 | B4 |
| F5 | E5 | A1 | A3 | 50/50 | B5 |
| F6 | E6 | A1 | A3 | 50/50 | B6 |
| F7 | E7 | A1 | A3 | 50/50 | B7 |
| F8 | E8 | A2 | — | 100 | B1 |
| F9 | E9 | — | A4 | 100 | B1 |
| F10 | E10 | A2 | A4 | 50/50 | B1 |
| F11 | E11 | A1 | A3 | 100 | B8 |
| F12 | E12 | A1 | A3 | 100 | B9 |
| F13 | E13 | A2 | — | 100 | B7 |
| F14 | E14 | — | A4 | 100 | B7 |
| F15 | E15 | A1 | A3 | 50/50 | — |
| F16 | E16 | A1 | — | 100 | B1 |
| F17 | E17 | — | A3 | 100 | B1 |

### (Evaluation Method)

### <<Observation of Toner Cross-Section>>

Observation of a toner cross-section was done by the following conditions. The structure a and the lamellar crystalline structure b were confirmed. Based on the measuring method as described above, cross section ratios in crystalline structure and a cross-section ratio (A/B) were determined.

Apparatus: Electron microscope “JSM-7401F” (made by JEOL Co. Ltd.)

Sample: A thin slice of a toner particle (thickness of 60 to 100 nm) dyed with ruthenium tetroxide (RuO₄)

Acceleration voltage: 30 kV

Magnification: 500,000 times

Observation conditions: Transmission electron detector, bright-field image

### [Preparation Method of Thin Slice of Toner Particle]

About 1 to 2 mg of toner was placed in a 10 mL sample tube in a way that the toner spread in the tube. The toner was treated under a dying condition with a vapor of ruthenium tetroxide (RuO₄), then it was dispersed in a photo curable resin “D-800” (made by JEOL Co. Ltd.) and photo cured to form a block. Subsequently, an ultra-thin slice sample having a thickness of 60 to 100 nm was cutout from the block using a microtome equipped with a diamond blade. Afterward, the cut out sample was again treated under the following conditions for dying.

### [Treatment Condition of Ruthenium Tetroxide]

A ruthenium tetroxide condition was done by using a vacuum electron dying apparatus VSC1R1 (made by Filgen Co. Ld.). Followed by the operation procedure of the apparatus, a sublimation chamber including ruthenium tetroxide was placed in a dying apparatus main body. After introducing a toner or an ultra-thin slice sample in the dying chamber, a dying treatment with ruthenium tetroxide was carried out under the condition of: room temperature (24 to 25° C.), a density 3 (300 Pa) for duration of 10 minutes.

### [Observation of Dispersed Particles]

After completion of dying, the sample was observed with an electron microscope “JSM-7401F” (made by JEOL Co. Ltd.) within 24 hours.

### <<Evaluation of Low-Temperature Fixing Property>>

As an image-forming apparatus, it was used a multi-function printer “bizhub™ C754” (made by Konica Minolta, Inc.) with modifying the fixing device in such a manner that the surface temperature of the fixing upper belt and the fixing under roller was adjustable. The above-described developers G1 to G17 were respectively charged to the apparatus. As a paper for evaluation, “mondi Color Copy A4 90 g/m²” (made by Mondi Co. Ltd.) was used. A fixing test was repeatedly conducted to fix a solid image having an amount of adhered toner of 11.3 g/m² under the conditions of: nip width of 11.2 mm, fixing time of 34 msec, fixing pressure of 133 kPa, and fixing temperature from 100° C. to 200° C. by changing the fixing temperature with a step of 5° C. The fixing tests were repeated until the moment of appearing cold offset. The lowest surface temperature of the fixing upper belt without producing cold offset was checked. This temperature was recorded as a lowest fixing temperature and the low-temperature fixing property was evaluated. The evaluation results are listed in Table 4. Here, in the evaluation test, “a fixing temperature” indicates a surface temperature of the fixing upper belt. When the lowest fixing temperature is smaller, it indicates that it is excellent in the low-temperature fixing property.

### <<Document Storage Stability>>

A modified apparatus of “bizhub™ C754” (made by Konica Minolta, Inc.) was used. A non-fixed image was formed on a recording material “POD gloss coat paper a4 128 g/m²” (made by Oji Paper Co. Ltd.) in a patch of 3 cm×2 cm with an amount of adhered toner of 10 g/m². The non-fixed image was fixed under the conditions of: nip width of 11.2 mm, fixing time of 34 msec, fixing pressure of 133 kPa, and glossiness of 60 with 75 degree glossiness meter. Then, the image portion with the non-image portion, and the image portion with the image portion were superposed facing each other. A weight was placed to the superposed portion to have a pressure of 100 g/cm². The test sample was left in a constant-temperature and constant-humidity chamber with 55° C. and 55% RH for 5 days. After leaving the test sample under these conditions, the degree of the image defect of the superposed two pieces of fixed images were evaluated according to the following 5 grades of Rank 1 to Rank 5. In the present invention, Rank 1 to Rank 3 are acceptable.

Rank 1: The image portions are adhered with each other, and the fixed images are peeled off with the paper. The image defect is severe, and definite image transfer to the non-image portion is observed.

Rank 2: The image portions are adhered with each other, as a result, there are produced image defects of white spots in plural portions of the images.

Rank 3: When two superposed images are separated, there is produced roughness or decrease of gloss on the surface of the respective fixed images. However, there is produced practically no image defect. The image deterioration level is acceptable. A small amount of image transfer to the non-image portion is observed

Rank 4: When two superposed images are separated, there is produced a cracked noise. A very slight amount of image transfer to the non-image portion is observed. But, there is produced no image defect, and the image deterioration level is acceptable.

Rank 5: Image defect or image transfer is not observed in both of the image portion and the non-image portion.

### <<Fixing-Separation Property>>

A modified apparatus of “bizhub™ C754” (made by Konica Minolta, Inc.) was used. A recording material “Kanefuji 85 g/m2 longitudinal direction” (made by Oji Paper Co. Ltd.) was left in the normal temperature and normal humidity atmosphere (temperature of 25° C. and relative humidity of 50%). On this paper was formed a solid image having an amount of adhered toner of 4.0 g/m² under the normal temperature and normal humidity atmosphere (temperature of 25° C. and relative humidity of 50%) with the conditions of: nip width of 11.2 mm, fixing time of 34 msec, fixing pressure of 133 kPa, and fixing temperature of 170° C. at fixing the upper belt. It was produced a test print having a front margin of 8 mm. Then, test prints were produced by changing a front margin of 7 mm, 6 mm and less with a step of 1 mm unit. The printing test was repeated until the moment of producing a paper jam. The minimum front margin that did not produce a paper jam was checked. The fixing-separation property was evaluated by this value. The evaluation results are listed in Table 2. When the front margin is smaller, it indicates that it is excellent in the fixing-separation property. In the present invention, evaluation criteria ◯ and \hat{◯} are recognized to pass the examination.

### (Evaluation Criteria)

\hat{◯}: Front margin is 2 mm or less

◯: Front margin is larger than 2 mm to 3 mm or less

Δ: Front margin is larger than 3 mm to 4 mm or less

×: Front margin is larger than 4 mm

### <<Printing Durability>>

A modified apparatus of “bizhub™ C754” (made by Konica Minolta, Inc.) was used. Continuous printing was done by using the prepared developer under high-temperature and high-humidity atmosphere (temperature of 33° C. and relative humidity of 80%) to evaluate printing durability.

Specifically, the prepared developer was loaded at a position of Cyan, and character charts of cyan single color having a printing ratio of 5% were continuously printed. A half-tone image print was printed out at the moment of producing each 100,000 prints. The half-tone image print was examined to check whether an image stain (fog) or a white line is produced. It was recorded the number of print sheet in which the image stain or the white line was observed. In the present invention, evaluation criteria Δ, ◯ and \hat{◯} are recognized to be acceptable.

\hat{◯}: Image stain or white line is not generated until 1,000,000 prints

◯: Image stain or white line is generated between 800,000 or more prints and less than 1,000,000 prints

Δ: Image stain or white line is generated between 600,000 or more prints and less than 800,000 prints

×: Image stain or white line is generated at the moment of less than 600,000 prints.

TABLE 4

| | | State of crystalline resin by cross-section observation | | | | | | | | | |
|---|---|---|---|---|---|---|---|---|---|---|---|
| | | | | Cross-section ratio of | | | | | | | |
| | | | | crystalline structure | | | | | | | |
| | | | | | Lamellar | | Property evaluation | | | | |
| | | Average domain size | | | crystalline | | Lowest | | | | |
| | External | | Lamellar | Structure | structure | Cross- | fixing | | | | |
| | additive- | | crystalline | (a) contain- | (b) contain- | section | temper- | Document | Fixing- | | |
| | added | Structure | structure | ing region | ing region | ratio | ature | storage | separation | Printing | |
| Developer | toner | (a) (nm) | (b) (nm) | (A) (%) | (B) (%) | (A/B) | (° C.) | stability | property | durability | Remarks |
| G1 | F1 | 1100 | 800 | 12 | 9.0 | 1.3 | 150 | 5 | ⊚ | ⊚ | Inv. |
| G2 | F2 | 1000 | 700 | 12 | 7.0 | 1.7 | 150 | 4 | ◯ | ◯ | Inv. |
| G3 | F3 | 1200 | 800 | 11 | 8.0 | 1.4 | 150 | 4 | ⊚ | ◯ | Inv. |
| G4 | F4 | 1100 | 1100 | 11 | 10.0 | 1.1 | 150 | 4 | ◯ | ◯ | Inv. |
| G5 | F5 | 1000 | 850 | 12 | 7.0 | 1.7 | 150 | 4 | ◯ | ◯ | Inv. |
| G6 | F6 | 900 | 600 | 15 | 7.0 | 2.1 | 150 | 4 | ◯ | ⊚ | Inv. |
| G7 | F7 | 1500 | 650 | 13 | 8.0 | 1.6 | 150 | 4 | ◯ | ⊚ | Inv. |
| G8 | F8 | 800 | 1500 | 12 | 8.0 | 1.5 | 155 | 4 | ⊚ | ◯ | Inv. |
| G9 | F9 | 1800 | 800 | 12 | 7.0 | 1.7 | 155 | 4 | ◯ | ◯ | Inv. |
| G10 | F10 | 1000 | 800 | 12 | 9.0 | 1.3 | 150 | 5 | ⊚ | ⊚ | Inv. |
| G11 | F11 | 300 | 250 | 3 | 2.5 | 1.2 | 150 | 3 | ◯ | ◯ | Inv. |
| G12 | F12 | 2100 | 1800 | 20 | 15.0 | 1.3 | 155 | 4 | ◯ | Δ | Inv. |
| G13 | F13 | 2100 | 600 | 15 | 5.0 | 3.0 | 150 | 4 | ◯ | Δ | Inv. |
| G14 | F14 | 300 | 1200 | 5 | 10.0 | 0.5 | 150 | 4 | ⊚ | Δ | Inv. |
| G15 | F15 | — | — | 0 | 0 | — | 180 | 2 | Δ | Δ | Comp. |
| G16 | F16 | — | 850 | 0 | 8.5 | 0 | 150 | 2 | ◯ | X | Comp. |
| G17 | F17 | 2000 | — | 10 | 0 | — | 150 | 3 | X | Δ | Comp. |

Inv.: Present invention
Comp.: Comparative example

As seen by the evaluation results in Table 4, it was found that the paper printed with an electrostatic image developing toner of the present invention was excellent in low-temperature document storage property, fixing-separation property and printing durability.

What is claimed is:

1. An electrostatic image developing toner comprising toner mother particles containing a binder resin and a releasing agent,
wherein the binder resin contains an amorphous polyester resin and a crystalline resin; and
the toner mother particles have a region (A) including a structure a formed with the releasing agent and the crystalline resin being in contact with each other, and a region (B) in which the crystalline resin forms a lamellar crystalline structure b independently existing without contacting with the releasing agent.

2. The electrostatic image developing toner described in claim 1, wherein the crystalline resin contains a crystalline polyester resin.

3. The electrostatic image developing toner described in claim 1, wherein the region (A) including a structure a has an average domain size in the range of 200 to 2,500 nm.

4. The electrostatic image developing toner described in claim 1, wherein the region (A) including a structure a has an average domain size in the range of 800 to 1,500 nm.

5. The electrostatic image developing toner described in claim 1, wherein the region (A) including a structure a has a cross-section ratio of 5 to 15% with respect to a cross-section of the toner mother particle.

6. The electrostatic image developing toner described in claim 1, wherein the region (B) in which the crystalline resin forms a lamellar crystalline structure b has an average domain size in the range of 100 to 2,000 nm.

7. The electrostatic image developing toner described in claim 1, wherein the region (B) in which the crystalline resin forms a lamellar crystalline structure b has an average domain size in the range of 500 to 1,500 nm.

8. The electrostatic image developing toner described in claim 1, wherein the lamellar crystalline structure b has a cross-section ratio of 5 to 10% with respect to a cross-section of the toner mother particle.

9. The electrostatic image developing toner described in claim 1, wherein the region (A) including a structure a and the region (B) formed with a lamellar crystalline structure b have a cross-section ratio (A/B) in the range of 1.0 to 2.5.

10. The electrostatic image developing toner described in claim 1, wherein the crystalline resin contains a hybrid crystalline resin formed with a crystalline resin segment and an amorphous resin segment.

11. The electrostatic image developing toner described in claim 10, wherein a content of the amorphous resin segment is in the range of 5 to 30% based on the total mass of the hybrid crystalline resin.
